(19) United States
(12) Patent Application Publication
(10) Pub. No.: US 2007/0029739 A1
(43) Pub. Date: Feb. 8, 2007

(54) Method for production of a sealing joint gasket

(75) Inventors: Laurent Jeanmart, Lesve (BE); Yves Lehmann, Liernu (BE); Dimitri Leroy, Liege (BE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SAINT-GOBAIN PERFORMANCE PLASTICS CHAINEUX S.A., Chaineux (BE)

(21) Appl. No.: 10/557,015

(22) PCT Filed: May 18, 2004
(86) PCT No.: PCT/EP04/05335

§ 371 Date: Nov. 16, 2005

(51) Int. Cl. F16J 3/00

(52) U.S. Cl. 277/634

(57) ABSTRACT

According to the invention, the method for the in situ production of a sealing bead between a first element and a second element is characterized in that one element chosen from the first and second elements is provided with a sealing bead (4) of defined shape and defined cross section; said sealing bead is characterized by a high flexibility and the presence of a highly hydrophobic, but not siliconized, surface giving the assembly an excellent watertight seal.

The present invention relates to a method of manufacturing a sealing bead, suitable for the assembly of a modular element ready to be fastened onto a frame or other surface.

The current trend, especially in the field of motor vehicles, is to facilitate vehicle assembly by reducing the number of assembly operations on an assembly line, equipment items and/or accessories fastened to the modular element having been premounted in a separate unit or workshop.

Thus, modular door elements for a vehicle are known which are generally in the form of a furnishing cover and are suitable for cooperating with the internal face of the vehicle's door so as to mask and protect the door closure mechanisms and/or the mechanisms provided within the door for moving the side windows.

The modular element is generally fastened to a door element by screwing, or by fit-in means, and it is necessary, at the interface between the modular element and the door element, to interpose a seal so as to protect the volume within said door from environmental attack (by moisture, dust, vibration, etc.).

For this purpose, it is known to interpose, as seal, at the interface between the two elements to be joined together, a foamed polymer sealing bead.

Although this foamed seal best fulfills its sealing function when the door element and the modular element cooperate with each other perfectly, it sometimes happens that, despite optimum fastening between the two facing elements, the seal is not sufficiently compressed over its entire perimeter and that a breach is opened, creating a possible passage for environmental attack. This situation generally arises from variations in the dimensional manufacturing tolerances on the door element and/or on the modular element, it being possible for these minimum tolerance values to occur at the same time.

To remedy this sealing deficiency, especially with regard to liquids such as water, it is common practice to compress the foamed seal to a degree of compression of greater than at least 30% and to use highly deformable seals that maintain intimate contact between the door element and the modular element.

However, such degrees of compression, following the clamping of the elements, and such relatively high deformations due to the material, may result in surface distortions, or visible defects, in the facing regions.

For the purpose of achieving the shortest possible assembly time for these modular elements, it appears to be desirable to pre-equip them with sealing means, on line and in a short time.

The object of the present invention is to propose a method of producing modular elements that are provided with sealing means and can be stored for a certain period, in order to be able to be mounted directly on a frame or any other receiving surface, especially a door element, with a limited number of operations.

The sealing means must be as effective as possible in order to guarantee that a seal is formed, with a low compression force, especially a seal against liquids, between the modular element and the receiving surface facing it.

This object, and others that will appear later, has been achieved with a method for the production of a sealing bead between a first element and a second element, characterized in that one element chosen from the first and second elements is provided with a sealing bead of defined shape and defined cross section, obtained by mixing a polyol compound with an isocyanate compound, having a flexible elastic portion, said sealing bead having a hydrophobic skin.

Thanks to the manufacture of a flexible hydrophobic sealing bead, it is possible to guarantee that there is a perfect seal between the two elements, even with a low assembly force.

In preferred embodiments, the invention may optionally have, in addition, one or more of the following arrangements:

the skin consists of a layer attached to the elastic portion;

the skin is manufactured as one part with the elastic portion;

the sealing bead is formed by extruding a one-component product;

the sealing bead is formed by coextruding the elastic portion with the skin;

the sealing bead is formed, in an extrusion head, by the reaction of at least two components fed separately into said extrusion head;

the skin is based on a hydrophobic polyol;

the hydrophobic polyol comprises hydrocarbon chains such as fatty acids;

the skin is formed from a thermally activatable, photoactivatable or chemically activatable compound;

the elastic portion has a relative density of less than 0.5, especially around 0.1 to 0.4; and

the sealing bead has a compression force of around 0.3 to 2 N/cm, preferably between 0.5 and 1.5 N/cm.

According to a further aspect, the subject of the invention is also an element, such as in particular a motor-vehicle door module, ready to be fastened onto a frame or other surface, which is characterized in that the element is provided with a sealing bead of defined shape and defined cross section, said sealing bead having at least one flexible elastic portion a portion obtained by mixing a hydrophobic polyol compound with an isocyanate.

The sealing bead may provide a damping function, by damping sound, contributing to the soundproofing of the assembly, or a shock or stress absorption function, by absorbing mechanical shocks or deformations.

It can also accommodate the tolerances on the bodywork dimensions.

As a variant, a protective film, even if this is not absolutely necessary, may be applied in order to prevent the external surface of the sealing bead from being soiled with dust, which could damage the seal.

It is possible to use, as film, a plastic film, especially one made of polyethylene, polyester, polyvinyl chloride, polyvinylidene chloride or polyamide, which film may or may not be coated with a coat of silicone.

According to another variant of the invention, the external portion of the sealing bead may exhibit, on the surface, adhesive properties.

The bond between the first and second elements is formed in the manner indicated below.

After having produced the sealing bead according to the invention by a method of manufacture that will be explained in greater detail below, the external surface of the sealing bead is made to cooperate with one of the opposing faces belonging to the first or second element, the elastic portion of the sealing bead then being mechanically stressed or deformed (for example in compression, in tension or in shear) between the two elements that have been brought together and immobilized by any means (screws, clipping-in, interlocking).

The method according to the invention allows a sealing bead to be shaped, making it possible to reproduce a sealing motif between two elements, advantageously when this motif is a closed curve following in particular at least one portion of the periphery of the modular element. Furthermore, the method makes it possible also to shape the cross section of the sealing bead so that it fits perfectly in the space that is reserved for it in the final assembly, taking account of its ability to be deformed.

According to one embodiment, the sealing bead is formed directly on one of the first or second elements.

A one-component or multicomponent product is deposited using an extrusion process, this product having to form the elastic portion of the sealing bead. In the case of a multicomponent product, the seal may be formed, in an extrusion head, by the reaction of at least two components fed separately into said extrusion head.

When the elastic portion of the sealing bead has been formed, and has achieved its desired cross section and its mechanical properties, especially in terms of flexibility, surface finish, hardness and degree of compression, it then presents a bonding surface. This bonding surface is intended to cooperate in a contact region of the other modular element (the first or the second one). The cooperation takes place by bringing together the opposing surfaces of each of the elements, taking care to compress the elastic portion of the seal so as in this way to seal the assembly, which is then fastened by any known means (screws for example).

According to another, different form of the previous embodiments, the sealing bead may be formed by depositing a moldable product on the layer forming the elastic portion in the cavity of the mold.

Depending on the way in which the modular element used is obtained, it is then possible:
either to form the sealing bead as one piece with one of the modular elements—it is therefore possible to mold the modular element (or at least a portion of the latter) directly on the sealing bead so as to produce the modular element (or the modular element portion) and the composite sealing bead at the same time;
or to form the bead separately from the modular element—it is possible either to transfer the composite bead onto a prefabricated modular element or to mold the modular element in contact with the sealing bead in said cavity.

The moldable product may be deposited in a closed mold by injecting a liquid. It is also possible to extrude a viscous or pasty material into a mold cavity (or to use another suitable method of delivery), with the aid of movable delivery means, the mold being stationary, or else with the aid of stationary delivery means, the mold then being movable.

If the elastic portion of the sealing bead is protected by a peelable film, the moldable material is chosen from those whose elastic modulus in the uncross-linked state is sufficient to allow the film to be peeled off without tearing the elastic portion of the sealing bead.

In particular, such materials comprise moisture-crosslinkable systems that can be protected by a moisture barrier film, especially systems of the one-component, preferably thermoplastic, polyurethane type, optionally modified by an elastomer. Such a system is a polyurethane prepolymer with a polyester, polyether or polyolefin backbone, obtained for example from a polyol and a hydrophobic isocyanate, one of which has a polymeric or oligomeric backbone as mentioned above.

As a variant, the composite sealing bead may be formed by depositing, into the mold cavity, the preformed, especially molded, elastic portion of the sealing bead, the superposition of the two portions in another mold allowing the precise shape of the sealing bead to be controlled. In this variant, the elastic portion of the preformed sealing bead may be an integral part of a modular element (or a portion of the latter) manufactured by molding.

Such a molding beam may be manufactured in particular by coextruding a skin if necessary on at least one of the faces of the elastic portion of the sealing bead, it being possible for the coextrusion product to be deposited in a mold cavity in order to adopt its final shape. The term “coextrusion” is understood here to mean both the formation of the elastic portion of the sealing bead simultaneously with the deposition of a skin, forming an impermeable surface around the body formed by the elastic portion by means of an extrusion head fed with at least two extrudable materials, and the application of at least one material forming the skin in an extrusion head through which the elastic portion of the sealing bead, formed beforehand, especially by extrusion, runs.

One method of manufacture consists in depositing, for example in a mold cavity, a moldable material constituting the elastic portion of the sealing bead (it being possible for this elastic portion to be optionally covered with an envelope forming a skin) and then in pressing one of the first or second elements against the elastic portion of the sealing bead in order to hold the sealing bead in place on said modular element. Next, the elastic portion of the sealing bead may optionally be at least partially cured in this mold, thus closed by the modular element, before said modular element on which the composite sealing bead has been fixed is removed. The curing of the sealing bead may be carried out or completed outside the mold, by cooling or by reaction with the moisture of the air.

The method according to the invention allows the manufacture in high volume of modular elements ready to be mounted, it being possible for this manufacture to be automated. The final assembly of these modular elements is very rapid and meets the requirement of reducing the assembly time for assemblies such as motor vehicles.

Other details and advantageous features will emerge below upon reading the description of illustrative, but nonlimiting, examples of the invention, given with reference to the appended drawings in which:

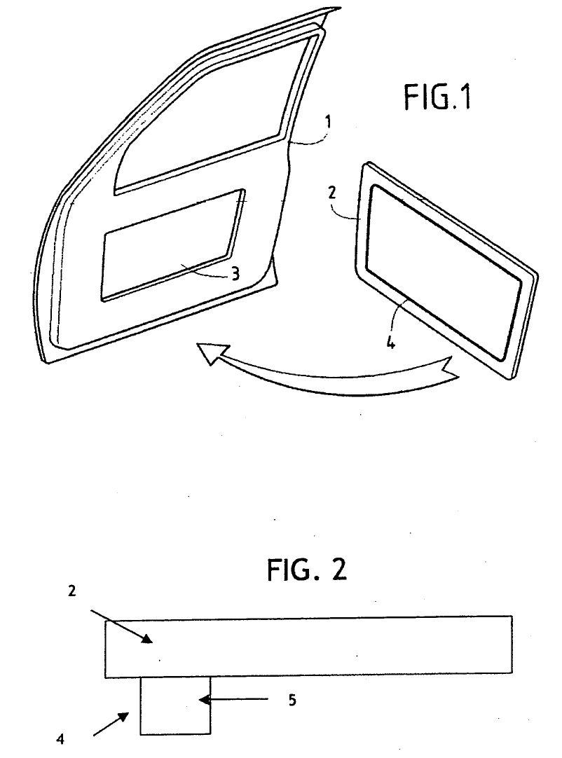

FIG. 1 shows a perspective view of the assembly of a door module on a motor vehicle door;

FIG. 2 shows a sectional view of the border region of the door module equipped with a sealing bead according to a first embodiment;

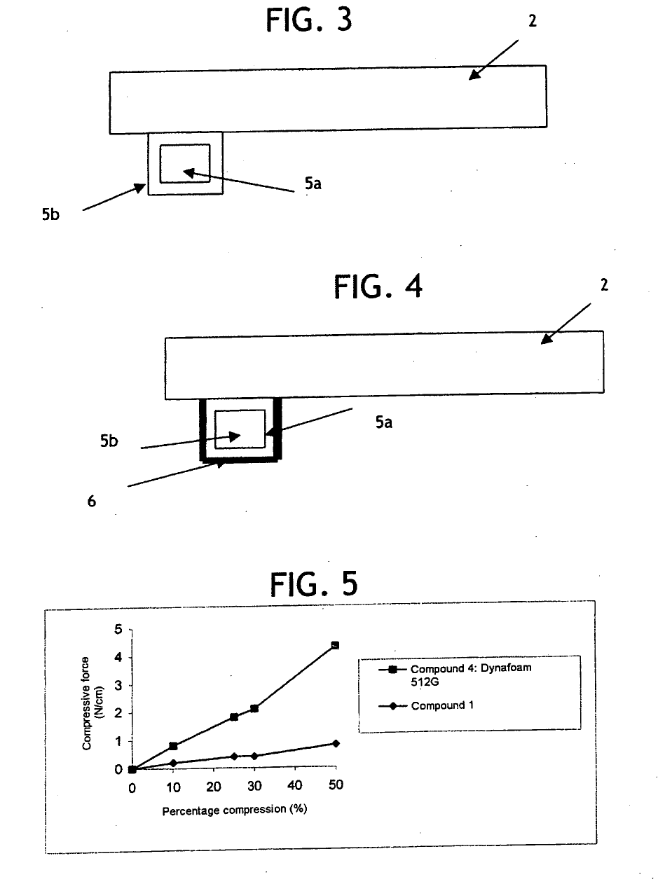

FIG. 3 shows a sectional view of the border region of the door module equipped with a sealing bead according to a second embodiment;

FIG. 4 shows a sectional view of the border region of the door module equipped with a sealing bead according to a third embodiment; and

FIG. 5 illustrates the variation in the compression force as a function of the degree of compression for two sealing beads.

It should firstly be pointed out that, for the sake of clarity, the various elements shown have not been drawn to scale.

FIG. 1 shows a perspective view of a first element, in particular a motor vehicle door 1 equipped with a second element, especially a door module 2 attached to a surface 3 or frame forming part of said door 1.

The door module 2 is shown in the unmounted position in order to reveal its face that is directed toward the surface 3 of the vehicle door 1. To simplify examination of the figure, no accessory or equipment has been shown on the door module, but it goes without saying that all the usual equipment, such as side pocket, etc. may be incorporated into this module.

The door module 2 is mounted on the surface 3 of the door 1 by interposing, between the internal face of the door module 2 and the surface 3 of the door 1, a flexible sealing bead 4. In this case, the seal motif is in the form of a closed frame running around the periphery of the door module. The sealing bead 4 must seal, especially against liquid, between the door module 2 and the door 1 and it may also provide other functions, such as the absorption of vibrations between the inner space and the outer space that are bounded by these two parts and also the fastening between the two elements.

The structure of the sealing bead 4 is according to the invention and may be seen in FIG. 2, which also shows the structure of the module 2. In this figure, the module is shown as it is before it is mounted on the vehicle.

The sealing bead 4 is formed from an elastic portion 5 bonded to one of the first or second elements. This elastic portion 5 is very flexible. The sealing bead 4 has a cross section calibrated according to the authorized gap between the first and second elements. In this case, the cross section is shown as being approximately square, but it may be of any other shape. To fulfill the sealing function, and to compensate for the bodywork manufacturing tolerances, the elastic portion 5 of the sealing bead 4 is made of a viscoelastic material.

This viscoelastic portion has a preferred composition, given below (all the proportions are expressed by weight):

According to a first composition, also called hereafter compound 1, the portion 5 of the sealing bead 4 may be based on:
1700 MW fatty-acid-based hydrophobic polyol (g): 50
4000 MW polyether polyol (g): 20
8000 MW polyether polyol (g): 25
480 MW polyether polyol (g): 5
distilled water (g): 1
siliconized surfactant (g): 1
triethylenediamine (catalyst) (g): 0.6
20/80 carbon black/diisodecylphthalate (DIDP) (g): 2
polymeric diphenylmethane diisocyanate (MDI) (g): 31

This seal has the following properties:
density (kg/m³): 200
Shore 00 hardness: 20
30% compression force (N/cm): 0.6 Pa·s.

The elastic portion of the sealing bead has a density of less than 0.5, especially around 0.1 to 0.4.

The elastic portion has a compression force of around 0.3 to 2 N/cm, preferably between 0.5 and 1.5 N/cm.

According to an alternative embodiment shown in FIG. 3, the elastic portion 5 of the sealing bead comprises a central portion or core 5a and a skin 5b. This portion 5b is highly hydrophobic. The skin 5b (cf. compound 3 below) may also cover a core 5a that is made from an intrinsically hydrophobic composition (cf. compound 2 below).

Thus, according to a second composition, called hereafter compound 2, the core 5a is based on:
polyether polyol (g): 50
4000 MW polyether polyol (g): 50
480 MW polyether polyol (g): 12.8
distilled water (g): 2
siliconized surfactant (g): 1
triethylenediamine (catalyst) (g): 0.6
20/80 carbon black/DIDP (g): 2
polymeric MDI (g): 50.1
   and possesses the following properties:
density (kg/m³): 125
Shore 00 hardness: 26
30% compression force (N/cm): 0.8 Pa·s.

According to yet another composition, also called hereafter compound 3, the skin 5b is based on:
1700 MW hydrophobic polyol (g): 100
siliconized surfactant (g): 0.5
triethylenediamine (catalyst) (g): 0.3
20/80 carbon black/DIDP (g): 2
polymeric MDI (g): 16.8
   and has the following properties:
density (kg/m³): ˜1050
water absorption: <0.1%.

Compounds 1, 2 and 3 are to be compared with the composition, called compound 4, with the aim of making a sealing bead according to the prior art. This compound 4 is based on Dynafoam 512G sold by the Applicant. This compound 4 has the following properties:
density: 340 kg/m³
Shore 00 hardness: 45
30% compression force (N/cm): 2.1

Sealing tests were carried out according to the U-test (Ford WSB-M3G102-B) standard on the various compounds 1, 2, 3 and 4, with the following results:

| | 30% | |
|---|---|---|
| | compression | U-test (Ford WSB- |
| | force (N/cm) | M3G102-B) |
| Compound 1 | 0.6 | OK |
| Compound 2 | 0.8 | not OK |
| Compound 3 | 0.8 | OK |
| Dynafoam 512G | 2.1 | OK |

All the sealing beads made from the various examples pass the U-test with the exception of compound 2, the polyols of which are 100% polyether polyols.

However, when this product (compound 2) is coextruded with another product composed of 100% hydrophobic polyol, so as to form a hydrophobic skin (compound 3), the flexible sealing bead thus formed passes the U-test. Consequently, the addition of a hydrophobic skin gives this bead sealing properties.

It may also be noted that the sealing beads formed from examples 1 and 3 are appreciably more flexible than Dynafoam 512G and seal at the same degree of compression (30%), which means that the force needed to compress these sealing beads will be substantially less. This effect may be seen in FIG. 5.

Given that both these products seal at 30% compression (i.e. they pass the U-test), the force to compress the flexible sealing bead (according to compound 1) will be substantially less than in the case of Dynafoam 512G.

In the graph shown in FIG. 5, the rate of compression of the seal is 2 mm/min.

In the embodiment shown in FIG. 4, the elastic portion 5 (more precisely its skin 5b) is protected by a film 6, allowing storage for a very long period when placed on the receiving part.

The purpose of the film 6 is generally to prevent, during the period of storage by the module manufacturer or by the automobile manufacturer, dust from soiling the sealing bead and to avoid any contact with a surface other than the final assembly surface, which could damage the elastic portion 5. The film also has the function of protecting the elastic portion from the external conditions, especially moisture, light, oxygen.

The sealing bead may be manufactured, for example, in the following manner:

Placed in the cavity of a mold is a film 6, that face of which in contact with the mold (which will be the external face of the film once the bead 4 has been completed) may be made of polyethylene so as to act as a release agent for the molded material. In a variant (not shown in the figures), the film 6 is deposited by spraying. The material of the elastic portion 5 of the sealing bead is deposited, on the internal face of the film 6, for example by means of an extrusion nozzle that is moved over the entire length of the cavity in a closed circuit (provision may also be made for the extrusion nozzle to remain stationary and for the mold to move relative to the nozzle). It is possible in this way to form a bead 4 in the shape of a frame, with no break, and therefore introducing no sealing defect. The nozzle may have a calibrated cross section in order to give a preliminary shape to the material of the elastic portion 5 of the bead 4, which ends up being shaped in the mold cavity.

As soon as the deposition of the material of the elastic portion 5 of the sealing bead 4 has been completed, the composite sealing bead can be installed on the door module, by transfer onto the latter: the door module is pressed against the external surface of the not yet cured bead 4 and the material adheres spontaneously to the surface of the module. As a variant, if the material of the bead 4 does not adhere spontaneously to the material of the module 2, it is possible to apply an optionally adhesive layer to the external surface of the elastic portion 5 of the cured or uncured sealing bead 4.

After a setting time, the length of which depends on the materials employed, the door module 2 can be removed from the surface of the mold with the composite bead 4 bonded to its surface. The film 6, if there is one, is also extracted from the mold cavity and remains attached to the elastic portion 5 or to its skin 5b, which it immediately protects from dust and/or moisture.

The module 2 thus equipped with the sealing bead 4 may be held for a long enough time for the bead to cure or for it to acquire structural properties; the module 2 is then stored until it is ready to be mounted on a vehicle.

The mounting operation is performed simply by removing the protective film 6, after which the bead 4 is pressed into contact with the door of the motor vehicle.

As a variant, the sealing bead 4 is formed directly on one of the first or second elements.

For this purpose, a one-component or multicomponent product is deposited directly on one of the faces of said element and in the desired sealing motif, this product having to form the elastic portion 5 (5a and 5b) of the sealing bead 4. In the case of a multicomponent product, the seal 4 may be formed, in an extrusion head, by the reaction of at least two components fed separately into said extrusion head.

The door module 2 has an identical structure to that of the module shown in FIGS. 2, 3 and 4. It is provided with an elastic portion 5 placed on the periphery of the module on or alongside the lining.

The elastic portion 5 is bonded, on a first face, to the module 2 and is optionally protected on another face by a film 6. The film 6 provides a moisture barrier function and is made, for example, of polyethylene.

The elastic portion 5 of the sealing bead 4 is manufactured in a very similar manner to that described above (with reference to the manufacture in the cavity of a mold), except as regards the deposition phase, which is carried out directly on the surface of one of the first or second elements, without passing via a transfer mold.

Moreover, the bead 4 may be applied to the second element (or to the first element) by pressing on the first element (or the second element), the sealing bead still having an active upper face for bonding to said (first or second) element, it being possible for the material of the core of the sealing bead to cure or set while the first and second elements are being held clamped against each other.

The invention has been described in the particular case of the manufacture of a door module ready to be mounted on a motor vehicle door frame, but it applies to the production of any other modular element, especially window modules that can be used in the automobile industry or in building construction (conservatories, porches, etc.).

1: A method for the in situ production of a sealing bead between a first element and a second element, characterized in that one element chosen from the first and second elements is provided with a sealing bead (4) of defined shape and defined cross section, said sealing bead having a flexible elastic portion (5) obtained by mixing a polyol compound with a polyisocyanate compound, the elastic portion (5) of the sealing bead (4) exhibiting, on its peripheral surface, a hydrophobic skin (5b) forming an impermeable envelope.

2: The method as claimed in claim 1, characterized in that the skin (5b) consists of a layer attached to the elastic portion (5).

3: The method as claimed in claim 1, characterized in that the skin (5b) is manufactured as one part with the elastic portion (5).

4: The method of claim 1, characterized in that the sealing bead (4) is formed by extruding a one-component product.

5: The method of claim 1, characterized in that the sealing bead (4) is formed by coextruding the elastic portion (5) with the skin (5b).

6: The method of claim 1, characterized in that the sealing bead (4) is formed, in an extrusion head (12), by the reaction of at least two components fed separately into said extrusion head.

7: A sealing bead (4) obtained by the method claim 1, characterized in that the skin (5b) is based on a hydrophobic polyol.

8: The sealing bead (4) as claimed in claim 6, characterized in that the hydrophobic polyol comprises hydrocarbon chains.

9: The sealing bead as claimed in claim 7, characterized in that the skin (5b) is formed from a thermally activatable, photoactivatable or chemically activatable compound.

10: The sealing bead as claimed in claim 6, characterized in that the elastic portion (5) has a relative density of less than 0.5.

11: The sealing bead as claimed in claim 7, characterized in that it has a compression force of around 0.3 to 2 N/cm.

12: An element, such as in particular a motor-vehicle door module (2), ready to be fastened onto a frame or other surface, characterized in that the element is provided with a sealing bead of defined shape and defined cross section, said sealing bead having at least one flexible elastic portion obtained by mixing a compound comprising a hydrophobic polyol with an isocyanate and having a compression force of around 0.3 to 2 N/cm.

13: The method of claim 2, characterized in that the sealing bead (4) is formed by extruding a one-component product.

14: The method of claim 3, characterized in that the sealing bead (4) is formed by extruding a one-component product.

15: The method of claim 2, characterized in that the sealing bead (4) is formed by coextruding the elastic portion (5) with the skin (5b).

16: The method of claim 3, characterized in that the sealing bead (4) is formed by coextruding the elastic portion (5) with the skin (5b).

17: The method of claim 2, characterized in that the sealing bead (4) is formed, in an extrusion head (12), by the reaction of at least two components fed separately into said extrusion head.

18: The method of claim 3, characterized in that the sealing bead (4) is formed, in an extrusion head (12), by the reaction of at least two components fed separately into said extrusion head.

19: A sealing bead (4) obtained by the method of claim 2, characterized in that the skin (5b) is based on a hydrophobic polyol.

20: A sealing bead (4) obtained by the method of claim 3, characterized in that the skin (5b) is based on a hydrophobic polyol.
